(19) United States
(12) Patent Application Publication
(10) Pub. No.: US 2026/0097744 A1
(43) Pub. Date: Apr. 9, 2026

(54) Y-CURTAIN FOR IMPROVED AERODYNAMIC AND BRAKING COOLING PERFORMANCE

(71) Applicant: FCA US LLC, Auburn Hills, MI (US)

(72) Inventors: Prathap Krishnan, Chennai (IN); Arturo Guzman-Magana, Auburn Hills, MI (US); Khaled Sbeih, Auburn Hills, MI (US)

(21) Appl. No.: 18/910,284

(22) Filed: Oct. 9, 2024

(51) Int. Cl. B60T 5/00; B62D 37/02

(52) U.S. Cl. CPC B60T 5/00; B62D 37/02

(57) ABSTRACT

A vehicle vent curtain has an inlet to enable air to enter the vent curtain. A first branch directs air flow to an external side of a vehicle. A second branch directs air to a wheel and brake, at a front end of a wheel well. Both branches are open so that flow simultaneously enters the wheel well from the second branch passing over a brake cooling the brake, and the first branch with the flow passing over the external side of the vehicle. This enhances air flow to improve brake cooling and aerodynamics.

### FIELD

The present disclosure relates to automotive vehicles and, more particularly, to an air curtain to improve aerodynamic and brake cooling performance.

### BACKGROUND

This section provides background information related to the present disclosure which is not necessarily prior art.

Air curtains exist in the automotive field. Air curtains aid in improving aerodynamic performance by passing air through openings in the front of the vehicle and exiting the flow in the rear arch to create a streamline flow around the wheels. However, air curtains do not impact brake cooling. Brake ducts are utilized in vehicles. Ordinarily, brake ducts in the vehicles are usually done by providing a profile underneath a vehicle or mounting a duct to carry the air from the front of the vehicle and exit in the wheel well and brake disk area. Both approaches added considerable drag to the vehicle. Thus, it would be desirable to have an air curtain or duct system that accomplishes both goals.

Accordingly, the present disclosure provides the art with an air curtain that improves aerodynamics and brake coolant performance. The present disclosure provides passage of air that enters from the front of the vehicle. This enhances streamlining of the flow outside of the wheel. Also, it enhances brake cooling by pushing hot air around the disk outside of the wheels. The present disclosures provides a single part for brake cooling and streamlining air flow. The present disclosure includes two paths for the air to take once it enters directly into the front of the vehicle. The one path directs the air to the environment around the brake disk to help take heat away. Another path continues to help reduce drag by streamlining the flow around the wheels to enable the air to exist the wheel arch at the side of the vehicle. The concealed design of the path cools the brake and also minimizes aerodynamic loss. The present disclosure is also cost effective and provides a single part.

### SUMMARY

This section provides a general summary of the disclosure, and is not a comprehensive disclosure of its full scope or all of its features.

According to an aspect of the disclosure, a vent curtain comprises an inlet to enable air to enter the vent curtain. A first branch directs air flow to an external side of the vehicle. A second branch directs air flow at a vehicle wheel and brake at a front end of a wheel well. Both branches are opened so that air flow entering the wheel well passes over a brake cooling the brake. The air flow from the first branch draws the flow to the external side of the vehicle to enhance aerodynamics. The second branch draws the flow to the brake disc area to enhance brake cooling. The first branch includes an outlet with an elongated rectangular configuration. The first branch has an overall rectangular configuration in cross section. The first branch is tapered so that the outlet has a larger length than the body of the first branch. The second branch has an outlet with an elongated rectangular configuration. The second branch has an overall rectangular configuration in cross section. The second branch tapers so that the outlet of the second branch has a larger length than the body of the second branch. The second branch has an overall L-shape configuration with a long leg having an outlet at its end. The end of the long leg includes the outlet angled with respect to the long leg to exit air flow towards a wheel well.

According to a second aspect of the disclosure, a vehicle including a vent curtain has a front fascia with an opening. The opening on the fascia is adjacent the vent curtain inlet to enable air flow to enter the vent curtain. The vent curtain includes a first branch directs air flow to an external side of the vehicle. A second branch directs air flow at a vehicle wheel and brake at a front end of a wheel well. Both branches are opened so that air flow entering the wheel well passes over a brake cooling the brake. The air flow from the first branch draws the flow to the external side of the vehicle to enhance aerodynamics. The second branch draws the flow to enhance brake cooling. The first branch includes an outlet with an elongated rectangular configuration. The first branch has an overall rectangular configuration in cross section. The first branch is tapered so that the outlet has a larger length than the body of the first branch. The second branch has an outlet with an elongated rectangular configuration. The second branch has an overall rectangular configuration in cross section. The second branch tapers so that the outlet of the second branch has a larger length than the body of the second branch. The second branch has an overall L-shape configuration with a long leg having an outlet at its end. The end of the long leg includes the outlet angled with respect to the long leg to exit air flow towards a wheel well.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view of a vent curtain on a vehicle.

FIG. 2 is a schematic perspective view of a vent curtain on the vehicle.

FIG. 3 is a perspective view of the vent curtain.

FIG. 4 is a cross-section view of FIG. 3 along line 4-4 thereof.

FIG. 5 is a cross-section view of FIG. 3 along line 5-5 thereof.

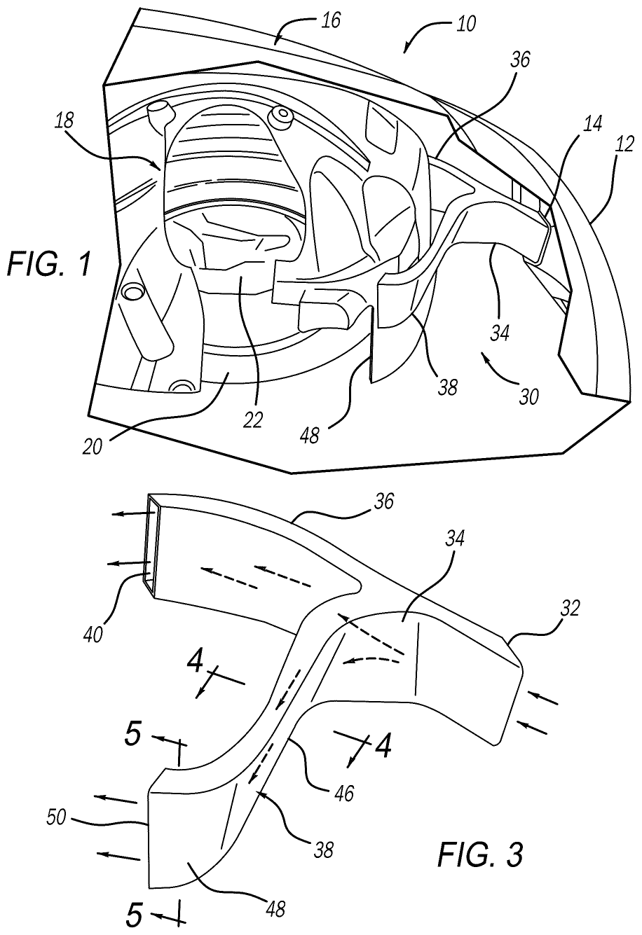

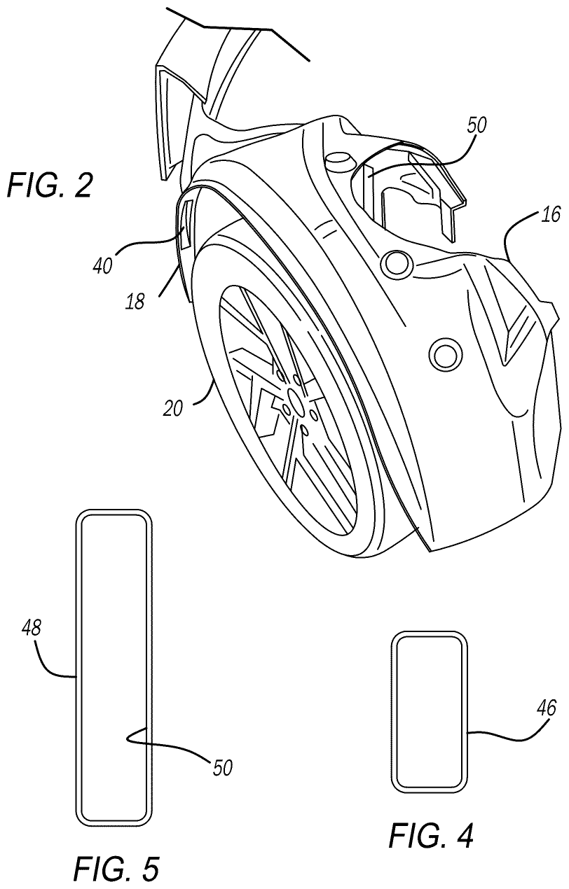

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle 10 includes a front fascia 12 having an aperture or inlet 14. Also, the vehicle 10 includes a body 16 that defines a wheel well 18. The wheel well 18 includes a wheel 20 that includes a brake 22. A vent curtain 30 is coupled between the fascia 12 and the wheel well 18.

The vent curtain 30 includes an inlet 32, a trunk portion 34, a first branch portion 36 and a second branch portion 38. The two branches 36, 38 split from the trunk 34. The inlet 32 is adjacent the fascia inlet 14 to enable air to flow into the curtain 30 via the inlet 32 into the trunk portion 34. The trunk portion 34 with the first branch 36 and second branch 38 define a Y-shape vent curtain 30.

The first branch 36 has an outlet 40 adjacent the side of the vehicle 10 to streamline the air flow at the outside of the wheel. This improves the aerodynamics of the vehicle 10. The first branch 36 has a rectangular cross section with a smaller height cross section at the trunk 24 and a larger height cross-section at the outlet 40. The first branch 36 tapers from the trunk 34 to the outlet 40. The outlet 40 has an elongated rectangular opening or configuration. This enables the air flow to be passed around the wheel well. Thus, the air curtain outlet 40 at the wheel well has an increased height as it moves around the wheel well.

The second branch 38 has an overall L-shape configuration with a long leg 46 and a short leg 48. The long leg 46 has an overall rectangular configuration in cross section and extends from the trunk towards the inside of the wheel well. The short leg 48 of the second branch 38 has a larger height cross sectional configuration than the long leg 46. Also, the short leg 48 includes an outlet 50 that exits inside the front of the wheel well directed at the vehicle brake 22. The outlet 50 has an elongated rectangular configuration to provide an increased height of the air curtain into the wheel well directed at the brake 22 to cool the brake 22. The outlet 50 of the second branch 38 is positioned at the front of the wheel well and is angled to be directed toward the wheel 70 and brake 22.

Thus, as the vehicle is moving, air is forced in through the inlet 32 of the air curtain 30. The air is divided in the trunk 34 with a portion moving towards the first branch 36 and the outside of the vehicle as well as into the second branch 38 and the inside of the wheel well. Both branches 36, 38 are open to receive the air flow that is divided and passed into both branches 36, 38. Thus, air flow is always passing to both branches 36, 38. The first branch 36 passes the air along the outside of the vehicle to improve its aerodynamics. The second branch 38 pushes the air at the wheel 20 and the brake 22 to cool the brake 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle vent curtain comprising:
an inlet for enabling air to enter the vent curtain;
a first branch for directing air flow to an external side of a vehicle;
a second branch for directing air at a wheel and brake, at a front end of a wheel well;
both branches being open so that flow simultaneously enters the wheel well from the second branch and passes over a brake cooling the brake and the air flow from the first branch passes to the external side of the vehicle for enhancing aerodynamics during brake cooling.

2. The vehicle vent curtain of claim 1, wherein the first branch includes an outlet having an elongated rectangular configuration.

3. The vehicle vent curtain of claim 2, wherein the first branch has an overall rectangular configuration in cross section.

4. The vehicle vent curtain of claim 3, wherein the outlet has a larger height dimension than the cross section of the first branch.

5. The vehicle vent curtain of claim 1, wherein the second branch has an outlet with an elongated configuration.

6. The vehicle vent curtain of claim 2, wherein the second branch has an overall rectangular configuration in cross section.

7. The vehicle vent curtain of claim 3, wherein the outlet has a larger height than the cross section of the second branch.

8. The vehicle vent curtain of claim 1, wherein the second branch has an overall L-shape configuration with a short leg having an outlet.

9. The vehicle vent curtain of claim 8, wherein an end of the short leg includes the outlet angled with respect to its body to exit air flow toward a wheel well.

10. A vehicle including a vent curtain comprising:
a front fascia including an opening;
an inlet on the air curtain adjacent the opening for enabling air flow to enter the air curtain;
a first branch for directing air flow to an external side of a vehicle;
a second branch for directing air at a wheel and brake, at a front end of a wheel well;
both branches being open so that flow simultaneously enters the wheel well from the second branch and passes over a brake cooling the brake and the air flow from the first branch passes to the external side of the vehicle for enhancing aerodynamics.

11. The vehicle vent curtain of claim 10, wherein the first branch includes an outlet having an elongated rectangular configuration.

12. The vehicle vent curtain of claim 11, wherein the first branch has an overall rectangular configuration in cross section.

13. The vehicle vent curtain of claim 12, wherein the outlet has a larger height dimension than the cross section of the first branch.

14. The vehicle vent curtain of claim 10, wherein the second branch has an outlet with an elongated configuration.

15. The vehicle vent curtain of claim 11, wherein the second branch has an overall rectangular configuration in cross section.

16. The vehicle vent curtain of claim 12, wherein the outlet has a larger height than the cross section of second branch.

17. The vehicle vent curtain of claim 10, wherein the second branch has an overall L-shape configuration with a short leg having an outlet.

18. The vehicle vent curtain of claim 17, wherein an end of the short leg includes the outlet angled with respect to its body to exit air flow toward a wheel well.
